(19) United States
(12) Patent Application Publication
(10) Pub. No.: US 2017/0273870 A1
(43) Pub. Date: Sep. 28, 2017

(54) ANIMAL SUPPLEMENTS OR MEDICATION ORGANIZER

(71) Applicant: Lenka RADOMIL, Campbellville (CA)

(72) Inventor: Lenka RADOMIL, Campbellville (CA)

(21) Appl. No.: 15/468,376

(22) Filed: Mar. 24, 2017

Related U.S. Application Data
(60) Provisional application No. 62/312,696, filed on Mar. 24, 2016.

(51) Int. Cl. A61J 7/04; B65D 21/02; A61J 7/00; B65D 43/16; B65D 25/20; A61J 1/14; B65D 25/04

(52) U.S. Cl. CPC A61J 7/04; A61J 1/1412; B65D 21/023; B65D 25/04; B65D 43/16; B65D 21/0206; B65D 25/205; A61J 7/0069

(57) ABSTRACT

The disclosure is directed at an animal supplements and/or medication organizer that includes a tray and a plurality of containers containing the supplements and/or medication. The plurality of containers can be different sizes to hold the supplements and/or medication, either in a solid (powdered or liquid) form. The tray includes a predetermined number of sections for receiving the containers.

### CROSS-REFERENCE TO OTHER APPLICATIONS

The application claims the benefit of U.S. Provisional Application No. 62/312,696 filed Mar. 24, 2016 which is hereby incorporated by reference.

### FIELD OF THE DISCLOSURE

The disclosure is directed generally to organizers and more specifically to an animal supplements or medication organizer.

### BACKGROUND OF THE DISCLOSURE

The feeding of supplements and medication to animals, such as horses, is often an unorganized task. Often, horses will get the wrong supplement, or medication, or horses will miss being fed their supplement or medication. One of the reasons is that a staff member in charge of taking care of the animals may be overwhelmed with too many animals to look after. It may also be due to instructions not being clearly explained to the staff member or members.

Feeding the wrong supplement or medication, or missing a supplement or medication can mean a serious risk to the animal in question. When an animal is fed the wrong supplement or medication, the animal could have an allergic reaction and get sick. The severity of the reaction could result in a need for surgery, or even death.

Another issue with feeding the wrong supplement or medication is that the animal could have a false positive drug test which may be problematic at events such as horse shows or horse competitions. If a horse goes to a horse show and tests positive for a banned substance, that horse will likely be disqualified and the trainer of the horse may lose their license and be banned from competing for a period of time. As most horse trainers ride and compete for a living, this could greatly affect their livelihood.

Furthermore, if a horse misses a supplement or medication, it could mean that the horse's health may be compromised. If the horse is receiving an antibiotic to clear up an infection, the healing process could be slowed. If the horse is receiving a pain killer, the horse may be in pain for that day or days that the pain killer is missed.

Unfortunately, the way supplements or medications are currently being fed is extremely inefficient. For horses, each horse typically has a bulk container of their supplement (sometimes multiple bulk containers of different supplements). All these bulk containers sit on a shelf in the feed room, sometimes labeled and sometimes not or are laid out in an unorganized fashion. It is common for public horse boarding stables to have upwards of 15 horses to care for and for each horse in the barn to be on at least one supplement. With an average of three supplements per horse, a minimum of 30 bulk containers of supplements may be sitting on shelves in a feed room. The staff member then refers to a chart to see which horse gets which supplements or medications for that day. In some cases, it is common for horses to get a treatment of medication every other day, which adds to the complications at feeding time. After reading the chart and knowing which supplement is needed, the staff member then needs to find the right container, open it, scoop out a serving of the supplement, and then add it to the horse's feed ration. This process must be repeated over and over, for each horse in the barn. At public boarding facilities that have a high number of animals, feed time becomes a very long and complicated process with an overwhelming amount of room for error.

Therefore, there is provided a novel method and apparatus for organizing animal supplements or medication.

### DESCRIPTION OF THE DRAWINGS

Embodiments of the present disclosure will now be described, by way of example, only, with reference to the attached Figures.

FIG. 1 is a perspective view of an animal supplements or medication organizer;

FIG. 2 is a front view of the animal supplements or medication organizer;

FIG. 3 is a perspective view of a pair of animal supplements or medication organizers in a stacked relationship;

FIG. 4 is another perspective view of a pair of animal supplements or medication organizers in a stacked relationship;

FIG. 5 is a cross-sectional view showing a pair of animal supplements or medication organizers in a stacked relationship;

FIG. 6 is a perspective view of the animal supplements or medication organizer with some containers removed;

FIG. 7 is a schematic diagram showing the insertion/removal of containers from a tray;

FIG. 8a is a schematic diagram of an animal supplements or medication organizer with small volume containers;

FIG. 8b is a schematic diagram of an animal supplements or medication organizer with large volume containers;

FIG. 8c is a schematic diagram of an animal supplements or medication organizer with small and large volume containers;

FIG. 9 is a perspective view of a set of small volume containers;

FIG. 10 is a bottom perspective view of the set of small volume containers of FIG. 9;

FIG. 11a is a bottom perspective view of the set of small volume containers with their lids open;

FIG. 11b is a top perspective view of the set of small volume containers with their lids open;

FIG. 12 is a schematic diagram of a set of small volume containers with their labels removed;

FIGS. 13a and 13b are schematic diagrams of another embodiment of a set of small volume containers;

FIG. 14 is a schematic view of a large volume container;

FIG. 15 is a side view of an open large volume container;

FIG. 16a is a perspective view of a first embodiment of a hinge of a large volume container;

FIG. 16b is a perspective view of a second embodiment of a hinge of a large volume container;

FIG. 17 is a perspective view of open and closed containers for use in an animal supplements and medication organizer;

FIG. 18 is a perspective view of open and closed small volume containers for use in an animal supplements and medication organizer;

FIG. 19 is a perspective view of open and closed large volume containers for use in an animal supplements and medication organizer;

FIG. 20 is a schematic diagram of a snap and lock mechanism for use with a container;

FIGS. 21a and 21b are perspective views of a second embodiment of an animal supplements and medication organizer;

FIG. 21c is a perspective view of a set of four small volume containers;

FIG. 21d is a perspective view of a tray in accordance with FIG. 21a holding only a plurality of four small volume container sets; and

FIG. 22 is a set of stacked animal supplements and medication organizers.

### SUMMARY OF THE DISCLOSURE

The disclosure is directed at an animal supplements or medication organizer. The organizer includes a plurality or set of containers which fit within a tray that holds the containers. The containers may be different sizes to hold different volumes of supplements or medication for the animal. In one embodiment, the tray is designed to include seven slots representing each day of the week so that the medication or supplements can be better organized and managed.

In one aspect of the disclosure, there is provided an animal supplements or medication organizer including a plurality of containers shaped to receive supplements or medication; and a tray for receiving the containers; wherein the containers are organized within the tray with respect to a date when contents of each of the plurality of containers is to be consumed.

In another aspect, the plurality of containers are a set of differently sized containers. Also, in another aspect, the tray includes seven slots for receiving seven sets of containers whereby each of the slots are labelled with a day of the week. In yet another aspect, the organizer further includes a label section. In yet a further aspect, the plurality of containers are removable from the tray.

In another aspect, each of the containers includes a storage portion; and a lid portion. In an aspect, the lid portion is in a hinged connection with the storage portion. In another aspect, each of the plurality of containers is a different colour.

In yet a further aspect, the organizer of includes a plurality of trays wherein the plurality of trays are stackable. In another aspect, the plurality of containers are large volume and small volume containers. In another aspect, the tray is designed to receive either the large volume or the small volume containers. In yet another aspect, at least some of the plurality of containers are attached together. In an aspect, each of the containers includes a ring of rubberized material to seal a connection between the lid portion and the storage portion. In an aspect, the plurality of containers store liquid or powdered material.

### DETAILED DESCRIPTION OF THE EMBODIMENTS

The disclosure is directed at a method and apparatus for organizing animal supplements and/or medication. The apparatus includes a tray that receives a set of containers containing the supplements and/or medication. The set of containers may be any size. In a preferred embodiment, the containers may be seen as large volume containers and small volume containers. In the following disclosure, use of the word supplements is also meant to refer to medication.

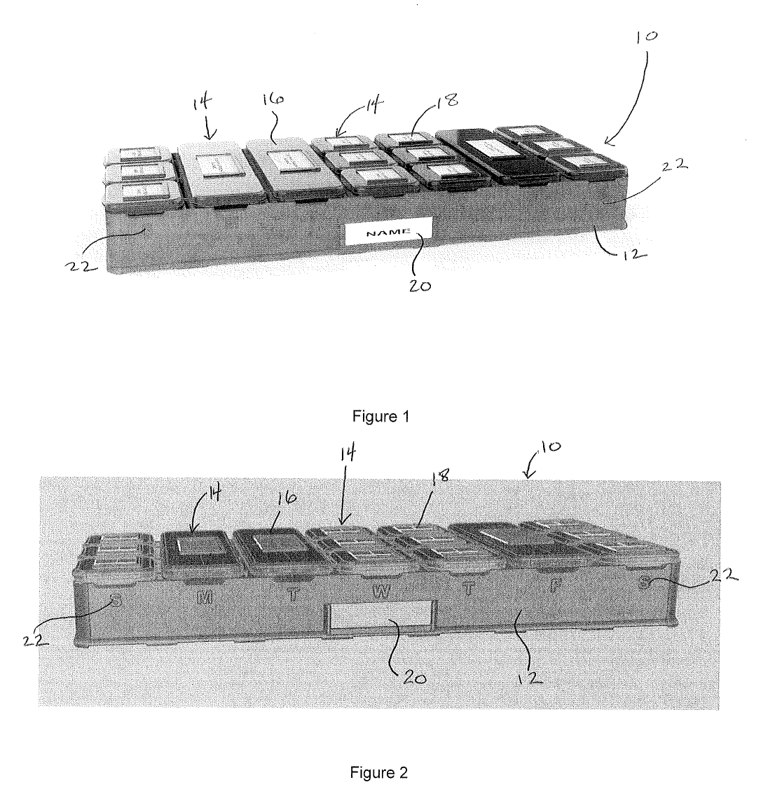

Turning to FIG. 1, a perspective view of an animal supplements organizer 10 is shown. The organizer 10 includes a base tray 12 that receives a plurality or set of containers 14 each containing supplements either in a liquid or solid form. In the solid form, the supplements or medication can be a powdered substance. In the current embodiment, the set of containers 14 includes both large volume containers 16 and small volume containers 18. In the current embodiment, the organizer 10 further includes a label section 20 within the base tray 12 for indicating the name of the animal to be fed the supplements and a date section 22 that assists to indicate the date when the supplements are to be fed to the animal. In a preferred embodiment, the date section 22 indicate the days Sunday through Saturday whereby each day of the week will have a separate compartment or section within the tray. In a preferred embodiment, the containers 14 are removable from the tray 12. The containers 14 preferably snap and lock into place to ensure they are secured to the tray 12 and that they will not fall out when handling the product or tray. Each removable container may be a different color to help distinguish between each day of the week. In one embodiment, the containers are manufactured out of plastic such as a medical grade plastic so that there will be no leakage of hazardous chemicals into the supplements or medication.

Turning to FIG. 2, a front view of the organizer 10 is provided. In FIG. 2, the date section 22 is more clearly shown whereby a more detailed view of the letters (S, M, T, W, T, F, S) representing Sunday through Saturday, on the front surface of the tray. The label section 18 can be changed if the organizer is needed for a different horse of a different name. Different coloured containers may represent the different volumes of compartments that will fit into the tray 12. The volumes of the containers will be described in further detail below.

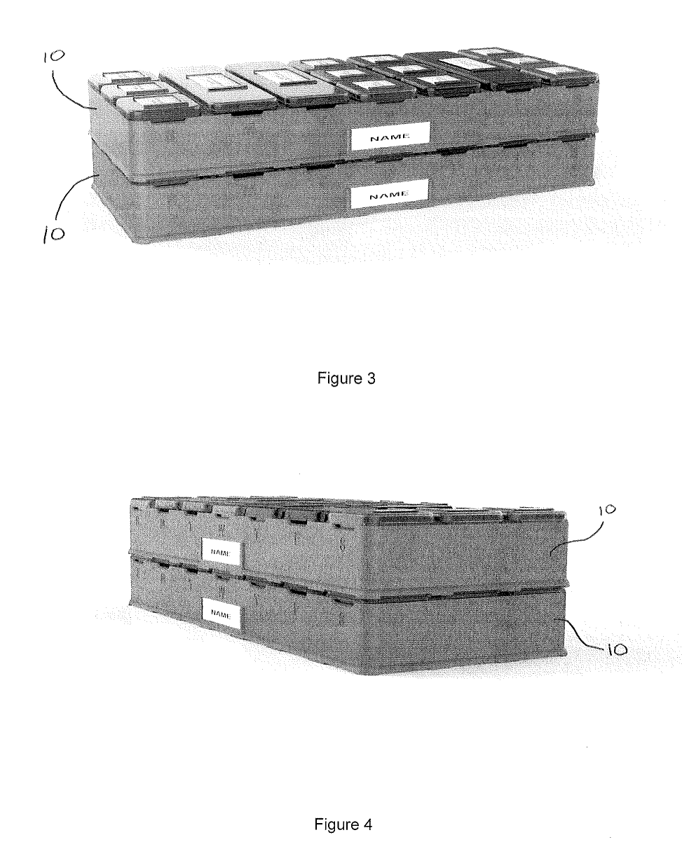

Turning to FIGS. 3 and 4, perspective views of a pair of organizers 10 in a stacked relationship are provided. In order to improve portability, multiple organizers can be stacked and carried at the same time. In stacking the trays, there is preferably a mechanism to allow the trays to be snapped and locked into place with respect to each other. By making the trays stackable, their storage is facilitated. Furthermore, this may also ensure the containers will not fall out and splay everywhere if the organizers are dropped. In one embodiment, a lid may be attached to the tray that will cover all of the containers whereby when the tray lid is snapped into place, a completely sealed box or case is achieved. Furthermore, the inclusion of a tray lid allow the trays to be stacked one on top of the other.

Turning to FIG. 5, a schematic cross-section of a pair of stacked organizers 10 is shown. As can be seen in the current embodiment, the trays include mechanisms allowing them to be locked and stacked one on top of the other. The trays can include the tray lids as well. The lid will lock in place and attach, the same way the tray is attaching to the containers shown here.

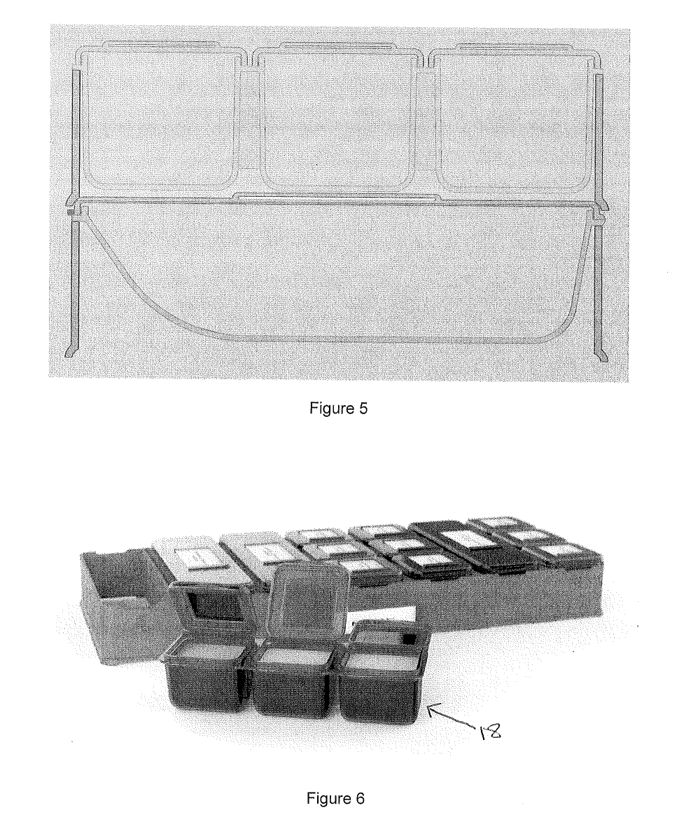

Turning to FIG. 6, a perspective view of an organizer having a set of containers removed is shown. In the current embodiment, the set of small volume containers 18 are attached together such that they can be fed at the same time to the animal. In use, the trainer or animal feeder can take the containers and pour them into a feed bucket or pouch whereby the animal can then eat the supplements along with their feed.

As such in the current embodiment, it can be seen that for the current day, the animal is fed three different types of supplements. Furthermore, each day of the week may have its own separate section within the tray from which the containers can be removed. In a preferred embodiment, the containers within one section are attached to each other whereby the lids of the containers preferably open and close separately with the lids of each container being attached to its associated container. After the animal is fed, the containers can be snapped back into place within the tray.

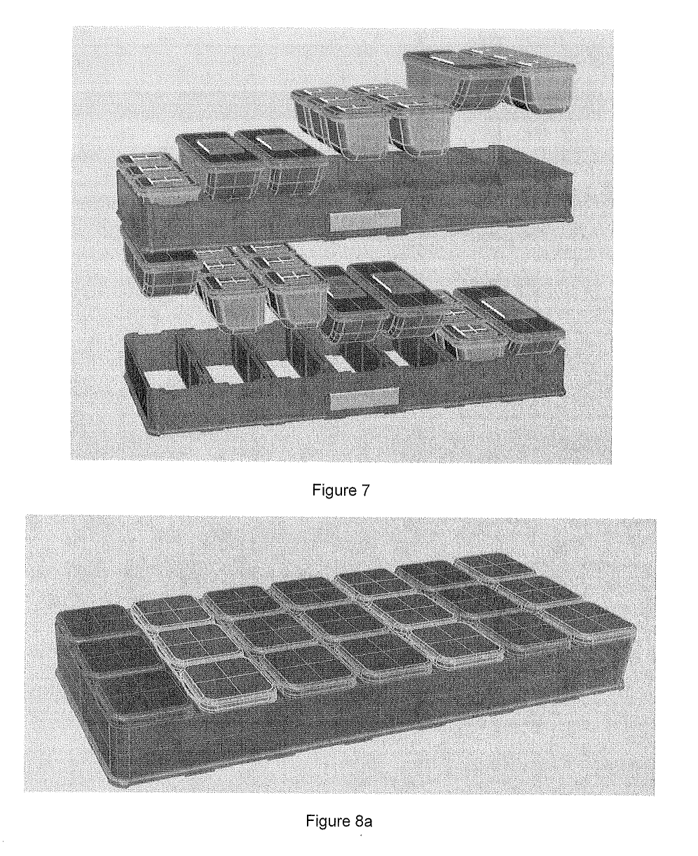

Turning to FIG. 7, a schematic diagram of containers being inserted or removed from the tray are shown. As can be seen, each container or set of containers can be taken out separately and put back in separately. As can be also seen, both large volume containers and small volume containers can fit into the same space within the tray such that, in the preferred embodiment, each section within the tray can receive either one large volume container or one set of three small volume containers. The organizer can be designed such that the tray is able to handle any number of containers in a set of small volume containers.

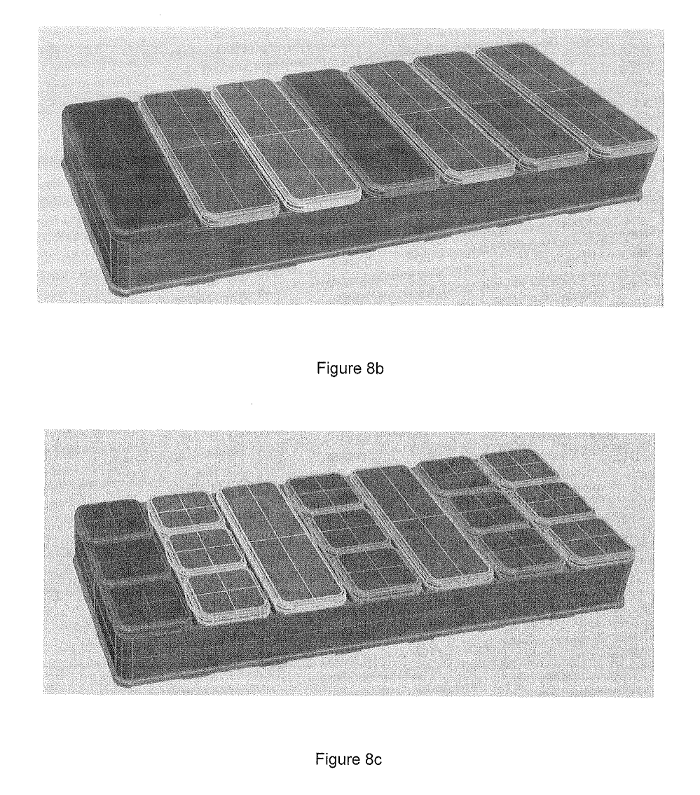

Turning to FIGS. 8a and 8b, perspective views of an animal supplements organizer containing only small volume containers and large volume containers are respectively shown. FIG. 8c is a perspective view of an organizer including both small and large volume containers. In the current figures, the large volume containers and small volume containers do not correspond with a particular day of the week, however, they may be interchanged as desired. This is where having different coloured containers may provide a benefit to the identification of the containers and contents. The tray may be used for all small volume containers (FIG. 8a) or all large volume containers (FIG. 8b) or a mixture (FIG. 8c) depending on the intended use by the animal owner.

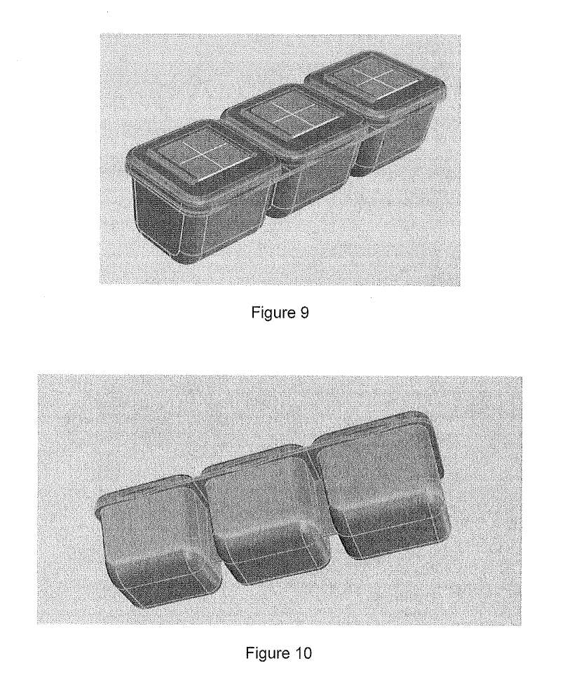

FIGS. 9 and 10 are perspective views of a set of small volume containers. The small volume containers have cells that are all attached together. In the preferred embodiment, the individual cells are rounded at the bottom and on the inside to make it easier for wiping down and cleaning. The closure between each cell bottom and its lid is preferably lined with a rubberized material to ensure the cell is air-tight when closed to maintain integrity and potency of the supplement or medication contained within.

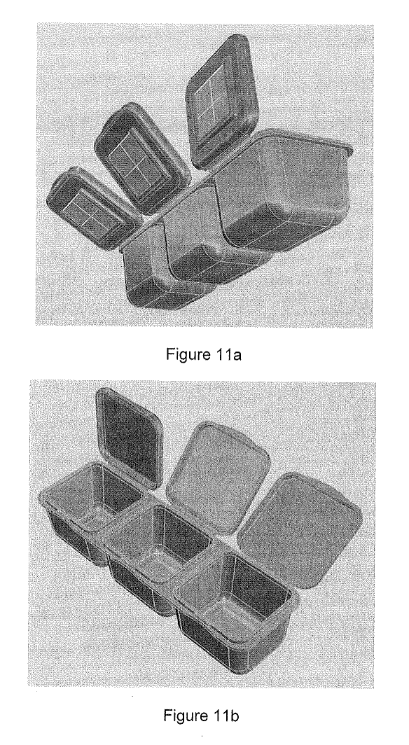

Turning to FIGS. 11a and 11b, perspective views of a set of small volume containers with their lids open are shown. As can be seen, the lids of the individual cells can open separately from one another, but the lids remain attached to its associated cell. In FIG. 11b, it can be seen that the interior of each cell is rounded at the bottom for easy cleaning. The containers and the tray may also be put in the dishwasher for cleaning.

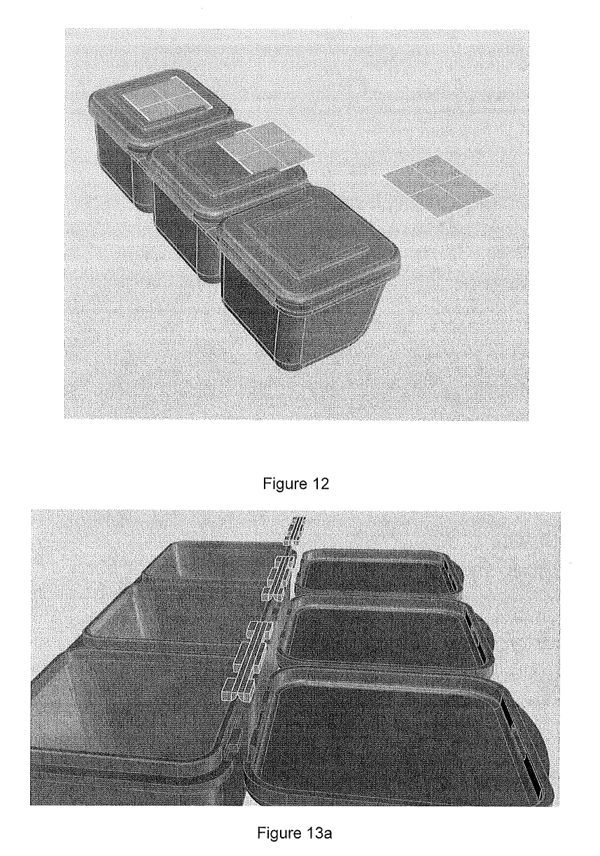

Turning to FIG. 12, a perspective view of a set of small volume containers with some labels removed are shown. The lids of each container has an area where a label can be added to note what supplement or medication is contained within the cell. The labels may be removed and changed, or removed completely if desired.

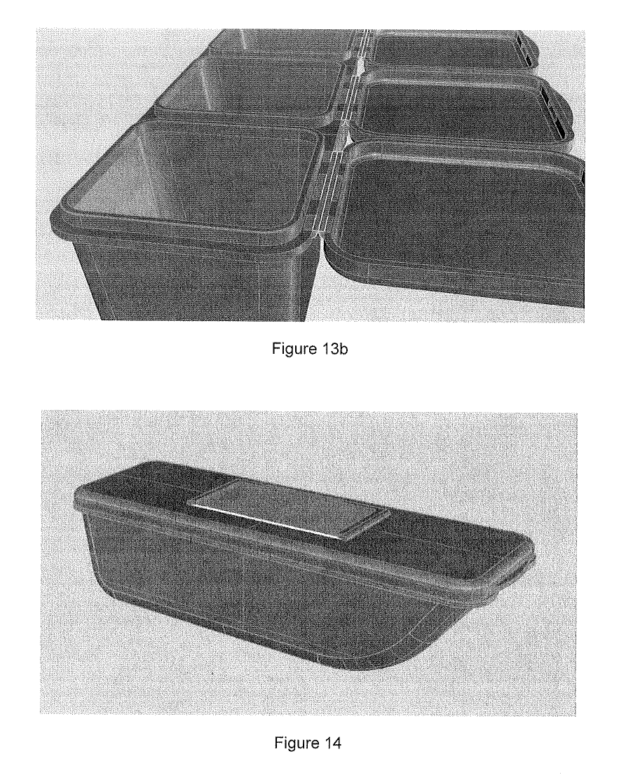

Turning to FIGS. 13a and 13b, two embodiments of hinges for use with the containers are shown. As can be seen, in the current embodiment, each cell within the small volume containers has its own lid attached to the cell, but each lid will have its own hinge, therefore each lid can be opened and closed separately.

Turning to FIG. 14, a perspective view of a large volume container is shown. This large volume container has a single cell, which is approximately the same size as the three cells of the smaller volume containers such that they can be interchanged within the tray. In use, the large volume container is preferably intended for supplements or medications that are of a larger serving size, or are liquid in form. As with the small volume containers, the closure between the lid and the cell preferably includes a rubberized trim to ensure the cell is air-tight and will not allow for any material to leak out when the product is being handled. This large volume container also includes an area for a label, which may be used in the same way as the labels of the small volume containers.

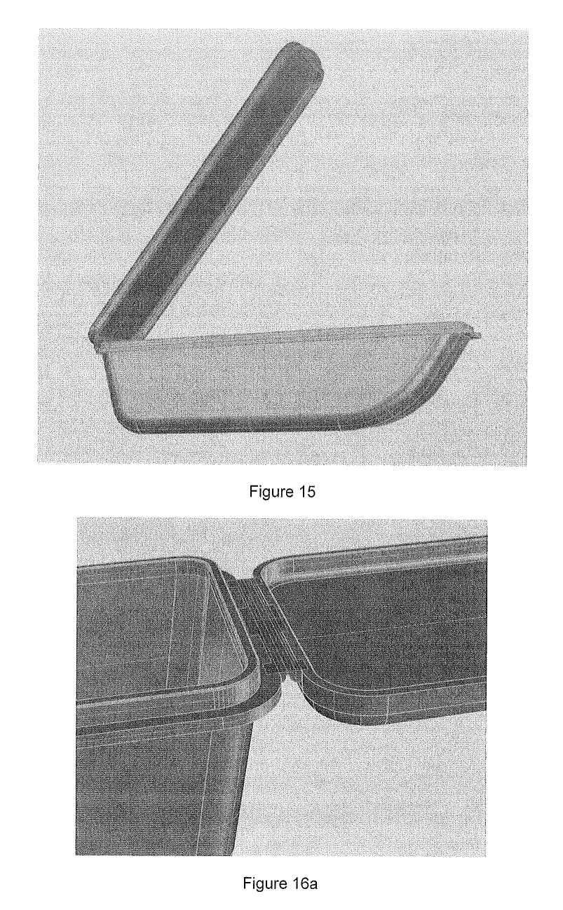

Turning to FIG. 15, a side view of an open large volume container is shown. The figure shows one possible shape for the large volume container. The curved bottom of the container preferably functions like a pouring-spout to make it easier for liquid to be poured out of the container. As with the small volume containers, the inside of the large volume container is preferably curved to allow for easy cleaning.

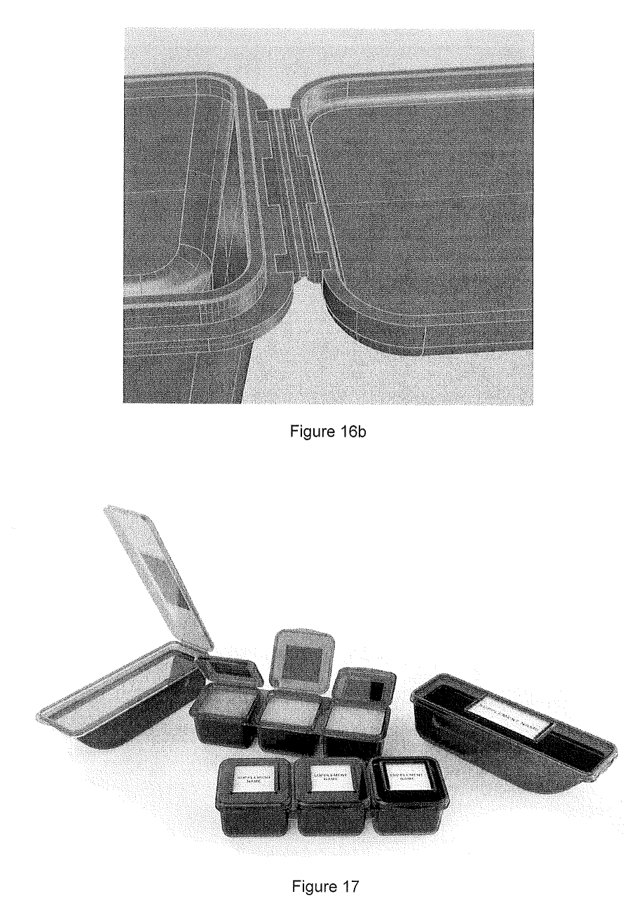

Turning to FIGS. 16a and 16b, two embodiments of a hinge for use with a large volume container are shown. The lid may (FIG. 16b) or may not (FIG. 16a) have a rib within the hinge to add more strength to the hinge.

Turning to FIG. 17, a perspective view of a set of small and large volume containers is shown. The containers are shown holding supplements and medications in either liquid or powdered form.

Turning to FIG. 18, a perspective view of open and closed small volume containers is shown reflecting an intended use for the small volume containers outside of the tray.

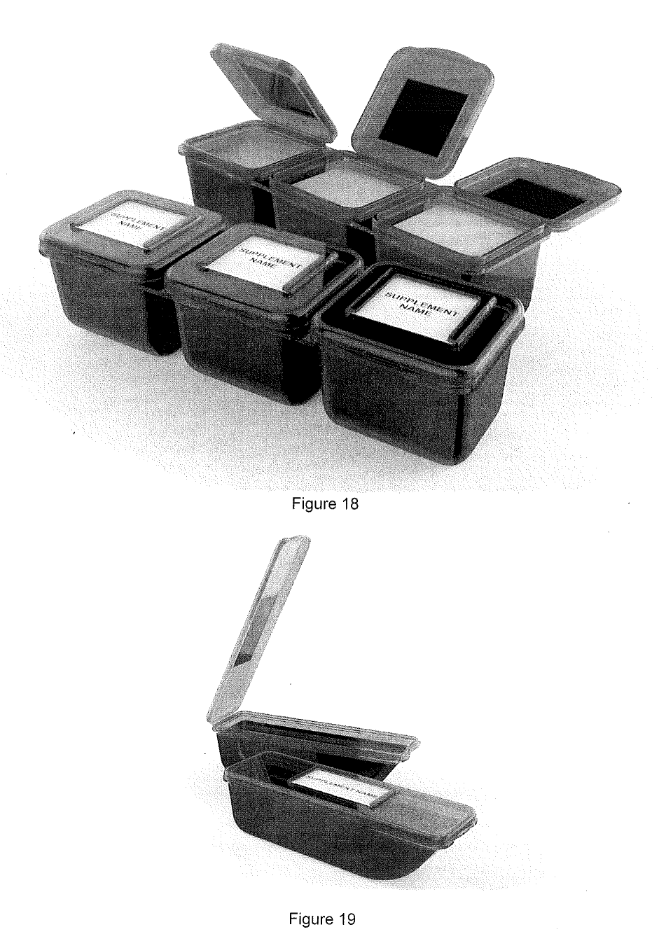

Turning to FIG. 19, a perspective view of a large volume container is shown reflecting an intended use for the large volume container outside of the tray.

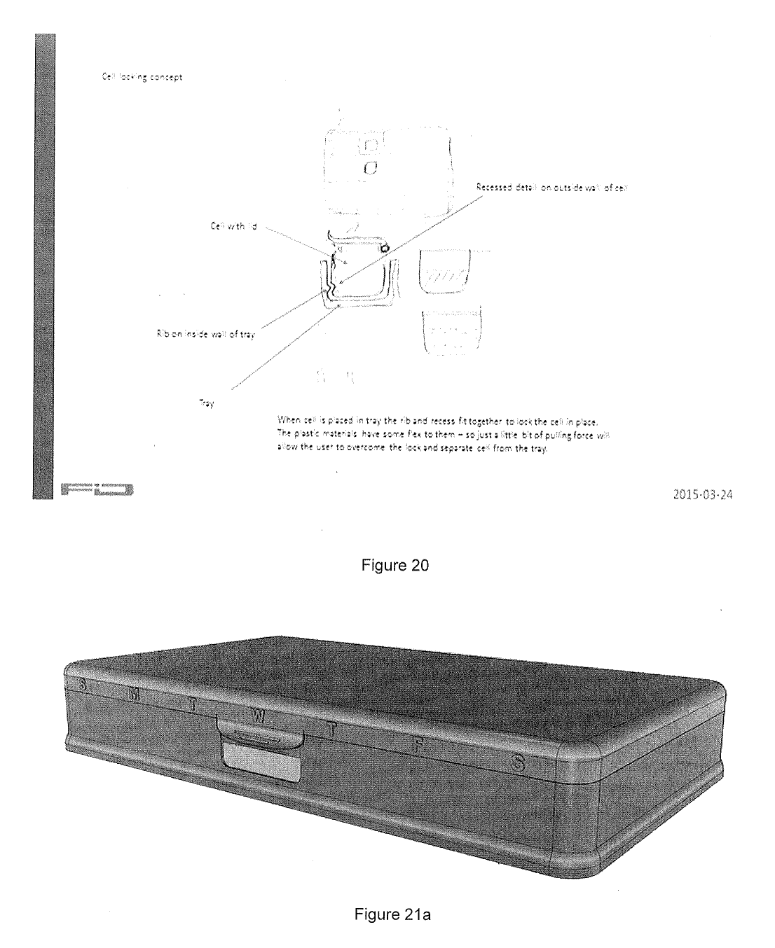

Turning to FIG. 20, a schematic diagram of a snap and lock mechanism is provided. FIG. 20 is directed at one embodiment of a snap and lock mechanism that can hold the removable containers in place within the tray. In the current mechanism, there is a rib on the inside of the tray that mates with a corresponding recessed detail on the outside of the wall of a container. These will snap in and hold the two separate pieces together. The removable containers can then be lifted out, with a small amount of force with human hands.

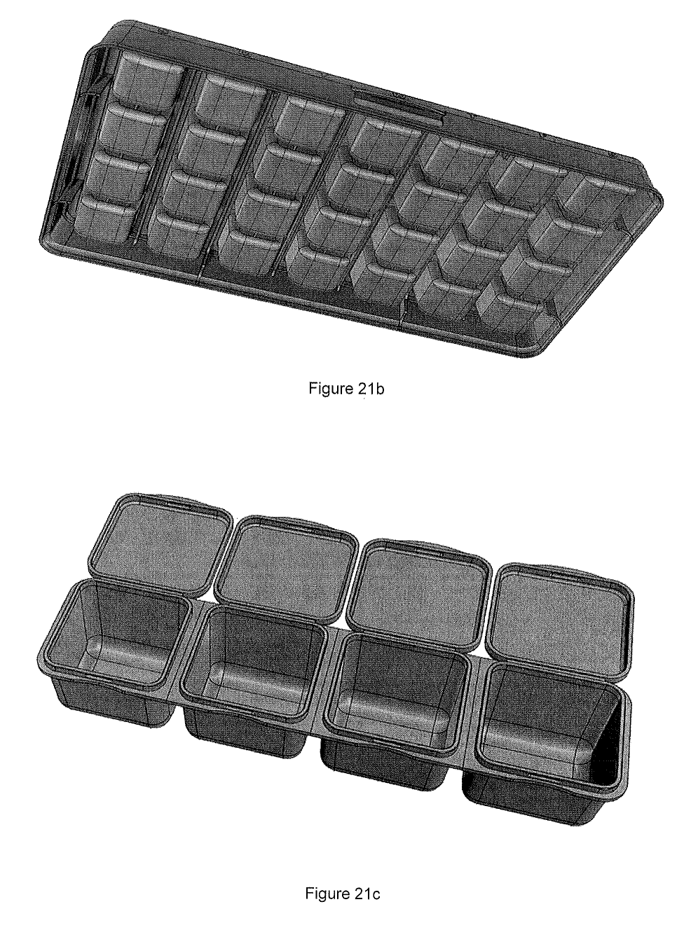

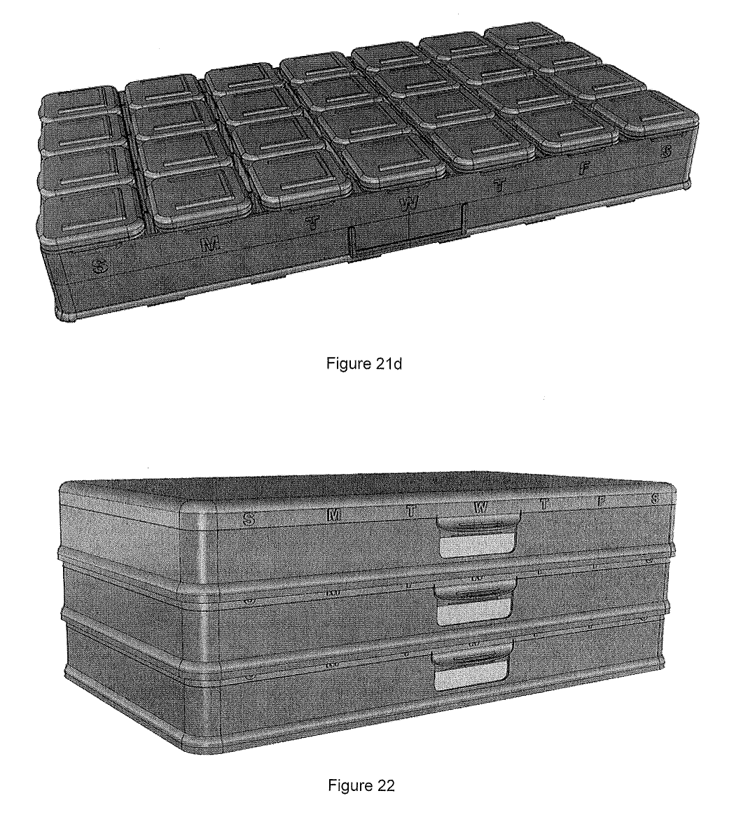

Turning to FIGS. 21a and 21b, perspective views of a second embodiment of a tray are shown. As can be seen in FIG. 21b, the tray is able to receive a set of four small volume containers rather than three. The large volume containers can be updated as necessary to fit within the tray of FIGS. 21a and 21b. FIG. 21c is a perspective view of a set of four small volume containers connected with each other while FIG. 21d is a perspective view of the tray of FIG. 21a holding only a plurality of four small volume container sets.

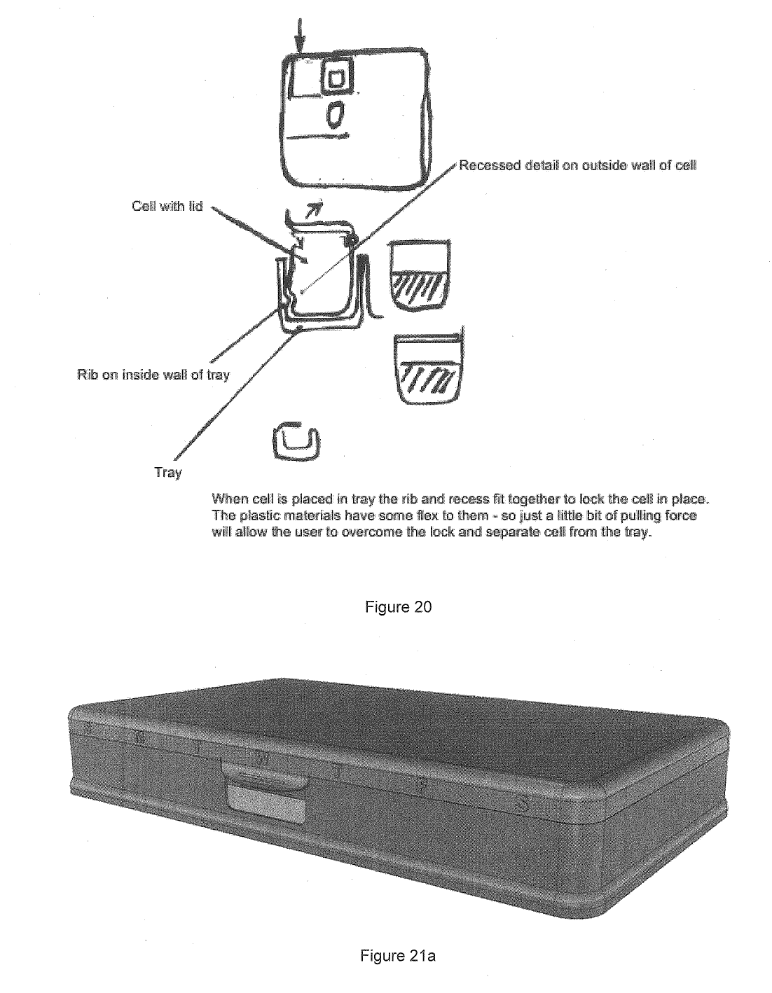

Turning to FIG. 22, a perspective view of a set of stacked animal supplement and medication organizers. As can be seen tray lids enclose the contents of the tray to protect the supplements inside from spilling everywhere in case they are accidently dropped. In a preferred embodiment, the lids for each tray include a secure latch on the top. The cases (combination of a tray and a tray lid) will be able to be stacked one on top of the other, to make for compact storage within the feed room, and also allowing for easy and organized transport when taking the horses off property to a horse show (and therefore needing to take their supplements/medications with them).

One advantage of the disclosure is that animal owners will experience benefits and conveniences in their everyday routine. Animal, such as horse, owners will be able to portion out the supplements and medications for their horse to consume on a daily basis. This will alleviate the stress that horse owners can sometimes experience. The horse owner can check the product daily, and see that the supplement for that day is not in the compartment anymore; therefore it has been fed to their horse. There will be no more worry of why the supplements in their bulk container are disappearing too quickly, or not fast enough.

Another advantage of the disclosure is that the organizer is customizable. If a horse suddenly gets sick or injured and is prescribed medication by a veterinarian, the horse owner will easily be able to add the medication into an empty container corresponding to the days that the horse should be given the medication. If the horse only needs to be on medication every-other-day, the horse owner only needs to fill every-other-day of the cell. There will alleviate or reduce confusion amongst staff members as to which day the horse should be given the medication and which day the horse should not. There will also be less confusion when trying to remember if the horse was given medication the day before, of if the horse is supposed to have medication that day.

Another advantage is that the label section provides an identification of the animal associated with the medication such that there is less chance of error in feeding the wrong supplement or medication to the wrong horse.

Another advantage of the disclosure is that there is a level of organization added to the feeding routine and which likely saves time, as a result. Instead of reading a chart, searching for a bulk container and scooping out the supplement (sometimes up to three or four times just for one horse) the barn staff will need to read the name of the horse on the label of the product, simply pull out the removable compartment that corresponds to that day of the week, and dump in the supplement. All supplements will be dumped into the correct feed bucket for the horse at one time; however, the supplements will have been stored separately in their own air-tight cell, so the integrity and potency of the supplement or medication will have been preserved.

Finally, another advantage of the disclosure is in time savings, which subsequently, leads to cost savings for the animal owner. Another advantage of the disclosure is that the potential risk of error at feed time is reduced.

Another benefit of the disclosure is that it is easy to transport supplements and/or medication for competitive horses that spend most of their summer off property, traveling to events. Now a week's worth of supplement can be packed up and taken to the horse show in one convenient organizer. For owners of multiple horses, all the horses that are travelling to the show can have their own case or organizer, neatly stacked and easy to transport, safe from spillage.

Another advantage of the disclosure is that each container is easy to clean and dishwasher safe, so it can be reused for years, therefore, reducing the amount of waste going into the landfill. Also, the contents of any container can be easily dumped out and refilled if the animal needs to be administered a new supplement or medication on short notice. In some cases, a container may be left empty if the supplements or medication is no longer needed.

While several embodiments have been provided in the present disclosure, it should be understood that the disclosed systems and methods might be embodied in many other specific forms within departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

What is claimed is:

1. An animal supplements or medication organizer comprising:
a plurality of containers shaped to receive supplements or medication; and
a tray for receiving the containers;
wherein the containers are organized within the tray with respect to a date when contents of each of the plurality of containers is to be consumed.

2. The organizer of claim 1 wherein the plurality of containers are a set of differently sized containers.

3. The organizer of claim 1 wherein the tray comprises seven slots for receiving seven sets of containers.

4. The organizer of claim 3 wherein each of the slots are labelled with a day of the week.

5. The organizer of claim 1 further comprising a label section.

6. The organizer of claim 1 wherein the plurality of containers are removable from the tray.

7. The organizer of claim 1 wherein each of the containers comprises:
a storage portion; and
a lid portion.

8. The organizer of claim 7 wherein the lid portion is in a hinged connection with the storage portion.

9. The organizer of claim 1 wherein each of the plurality of containers is a different colour.

10. The organizer of claim 1 further comprising a plurality of trays.

11. The organizer of claim 10 wherein the plurality of trays are stackable.

12. The organizer of claim 1 wherein the plurality of containers comprise large volume and small volume containers.

13. The organizer of claim 12 wherein the tray is designed to receive either the large volume or the small volume containers.

14. The organizer of claim 1 wherein at least some of the plurality of containers are attached together.

15. The organizer of claim 8 wherein each of the containers further comprises a ring of rubberized material to seal a connection between the lid portion and the storage portion.

16. The organizer of claim 1 wherein the plurality of containers store liquid or powdered material.
